(19) United States
(12) Patent Application Publication
(10) Pub. No.: US 2026/0161473 A1
(43) Pub. Date: Jun. 11, 2026

(54) ELECTRONIC DEVICE WITH ALLOCATION OF FUNCTIONS TO CORES

(71) Applicant: Samsung Electronics Co., Ltd., Suwon-si (KR)

(72) Inventor: Jaehyung AHN, Suwon-si (KR)

(73) Assignee: Samsung Electronics Co., Ltd., Suwon-si (KR)

(21) Appl. No.: 19/180,070

(22) Filed: Apr. 15, 2025

(30) Foreign Application Priority Data
Nov. 8, 2024 (KR) 10-2024-0158009

(51) Int. Cl. G06F 9/50

(52) U.S. Cl. CPC G06F 9/5044; G06F 9/5061

(57) ABSTRACT

Disclosed are an electronic device for allocating functions to a plurality of cores and executing the functions, and a method of operating the electronic device. The electronic device includes a processor including a plurality of cores and a memory storing instructions, wherein the instructions, when executed by the processor, cause the electronic device to: determine whether functions to be executed for each of independent input batches correspond to a target function that is one of preset fused functions; and execute the functions by allocating, based on a core allocation ratio corresponding to the target function, the functions to the plurality of cores, wherein each of the fused functions includes a compute-bound function having a computation time greater than a memory loading time and a memory-bound function having a memory loading time greater than a computation time.

### CROSS-REFERENCE TO RELATED APPLICATIONS

This application claims the benefit under 35 USC § 119(a) of Korean Patent Application No. 10-2024-0158009 filed on Nov. 8, 2024, in the Korean Intellectual Property Office, the entire disclosure of which is incorporated herein by reference for all purposes.

### BACKGROUND

### 1. Field

The following description relates to an electronic device for with allocation of functions to cores and execution of the functions.

### 2. Description of Related Art

The advancement in artificial intelligence (AI) technology has increased the need for AI-dedicated standalone hardware. AI may perform, for example, reasoning and learning through specific operations (or computations). As the dedicated hardware for implementing and executing AI, various devices are in development.

The AI-dedicated hardware may be implemented by, for example, a central processing unit (CPU), a graphics processing unit (GPU), a field-programmable gate array (FPGA), an application-specific integrated circuit (ASIC), or the like.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an electronic device includes: a processor including a plurality of cores; and a memory storing instructions, wherein the instructions, when executed by the processor, cause the electronic device to: determine whether functions to be executed for respective independent input batches correspond to a target function among preset fused functions; and execute the functions by allocating the functions to the cores, based on a core allocation ratio corresponding to the target function. Each of the fused functions may include a compute-bound function having a computation time thereof that is greater than a memory loading time thereof and a memory-bound function having a memory loading time thereof that is greater than a computation time thereof.

The core allocation ratio may be determined based on the runtime of the compute-bound function of the target function and the runtime of the memory-bound function of the target function.

The instructions may, when executed by the processor, cause the electronic device to: execute, using the target function, a function that is to be currently executed for one input batch among the input batches and a function that is to be currently executed for another input batch among the input batches, together on the processor.

The instructions may, when executed by the processor, cause the electronic device to: in response to execution of some of the functions included in a fused function being completed, allocate remaining functions to cores that have completed the execution and execute them thereon.

The instructions may, when executed by the processor, cause the electronic device to: divide some functions having a long runtime among functions included in the target function into unit functions; and in response to execution of remaining functions excluding the some functions being completed, allocate together some of the unit functions to cores different from cores to which the some functions are allocated and execute them thereon.

The instructions may, when executed by the processor, cause the electronic device to: divide some functions having a long runtime among the functions included in the target function into a plurality of tasks to be executed in parallel; and allocate some of the tasks to cores different from cores to which the some functions are allocated and execute them thereon.

The instructions may, when executed by the processor, cause the electronic device to: execute the functions, using data of the input batches, the target function, and parameters of the functions.

Each of the fused functions may include one or more compute-bound functions and one or more memory-bound functions, among the functions.

In one general aspect, an electronic device includes: a processor including cores; and a memory storing instructions, wherein the instructions, when executed by the processor, cause the electronic device to: determine whether functions to be executed for respective independent input batches correspond to a target function among preset fused functions; and execute the functions by allocating, based on a core allocation ratio corresponding to the target function and the number of processors for executing the functions, the functions to the cores and the processors, wherein each of the fused functions includes: a compute-bound function having a computation time thereof that is greater than a memory loading time thereof and a memory-bound function having a memory loading time thereof that is greater than a computation time thereof.

The instructions may, when executed by the processor, cause the electronic device to: in response to preset functions among the functions being executed for one input batch among the input batches, transmit a result value of the preset functions and information about a function to be executed subsequently to a subsequent processor among the processors.

The number of processors for executing the functions may be determined based on a runtime ratio between the functions.

In one general aspect, a method of operating an electronic device includes: determining whether functions to be executed for respective independent input batches correspond to a target function among preset fused functions; and executing the functions by allocating the functions to cores based on a core allocation ratio corresponding to the target function, wherein each of the fused functions includes: a compute-bound function having a computation time thereof that is greater than a memory loading time thereof and a memory-bound function having a memory loading time thereof that is greater than a computation time thereof.

Other features and aspects will be apparent from the following detailed description, the drawings, and the claims.

### BRIEF DESCRIPTION OF THE DRAWINGS

FIG. 1 illustrates an example of an electronic device according to one or more example embodiments.

FIG. 2 illustrates examples of a compute-bound function and a memory-bound function according to one or more example embodiments.

FIG. 3 illustrates an example of how an electronic device allocates functions to cores according to one or more example embodiments.

FIGS. 4 through 6 illustrate an example of how an electronic device allocates functions with different runtimes to cores according to one or more example embodiments.

FIG. 7 illustrates an example of how an electronic device uses preset fused functions according to one or more example embodiments.

FIG. 8 illustrates an example of classifying functions according to one or more example embodiments.

FIG. 9 illustrates an example of determining a fused function and a core allocation ratio according to one or more example embodiments.

FIG. 10 illustrates an example of allocating functions to cores according to one or more example embodiments.

FIGS. 11 and 12 illustrate an example of how an electronic device allocates functions to processors according to one or more example embodiments.

FIG. 13 illustrates an example of how an electronic device executes functions by allocating the functions to processors according to one or more example embodiments.

FIG. 14 illustrates an example of allocating functions based on the number of processors according to one or more example embodiments.

FIG. 15 illustrates an example of allocating functions to processors according to one or more example embodiments.

FIG. 16 illustrates an example of a method of operating an electronic device according to one or more example embodiments.

FIG. 17 illustrates an example of a configuration of an electronic device according to one or more example embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

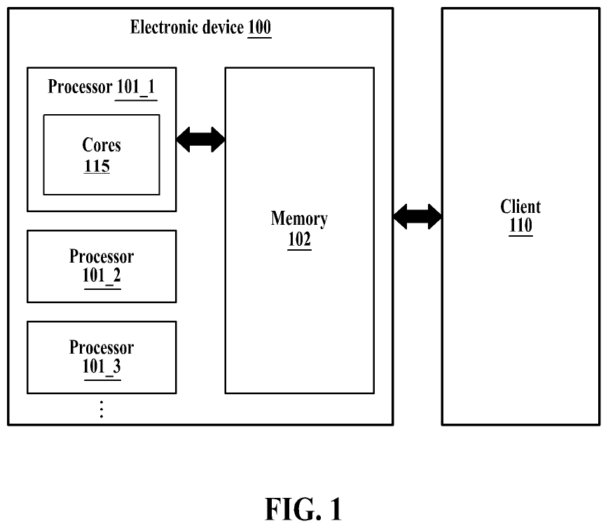

FIG. 1 illustrates an example of an electronic device according to one or more example embodiments.

Referring to FIG. 1, an electronic device 100 may include a processor 101_1 and a memory 102. In some embodiments, the electronic device 100 may also include one or more processors (e.g., 101_1, 101_2, 101_3, . . . ). The electronic device 100 may further include an accelerator (not shown). The components included in the electronic device 100 may communicate with each other via a bus. The electronic device 100 may include, as non-limiting examples, various computing devices such as a cellular phone, a smartphone, a tablet, an e-book device, a laptop, a personal computer (PC), a desktop, a workstation, or a server, various wearable devices such as a smart watch, smart glasses, a head-mounted display (HMD), or smart clothing, various consumer electronics such as a smart speaker, a smart television (TV), or a smart refrigerator, and others such as a smart car, a smart kiosk, an Internet of things (IoT) device, a walking assist device (WAD), a drone, or a robot.

The processor 101_1, which is a device configured to control the operations of the components included in the electronic device 100, may include, for example, a central processing unit (CPU) or a graphics processing unit (GPU). The processor 101_1 may include a plurality of cores 115 that may execute instructions. The processor 101_1 may receive a request to execute specific functions for input batches and, in response to the request, may transmit one or more instructions to the memory 102 or other processors 101_2 and 101_3. The request may be for artificial intelligence (AI)-based data inference, and may be to acquire a data inference result by causing the accelerator to execute a neural network for, for example, one for speech recognition, machine translation, machine interpretation, object recognition, pattern recognition, computer vision, or the like. For example, the request may be for data inference based on a large language model (LLM) for input batches received from a client 110. In response to the request, the processor 101_1 may allocate specific functions for the received input batches to the cores 115 to execute them, or allocate the functions to the one or more processors (e.g., 101_1, 101_2, 101_3, . . . ) to execute them. Alternatively, in some embodiments, the processor 101_1 may allocate specific functions to processors of the electronic device 100 and another electronic device (not shown) to execute them. In this case, the expression “execute or executing a function” may be construed as performing an operation (or computation) of the function. For example, the processor 101_2 and the processor 101_3 may be included in the other electronic device. The one or more processors (e.g., 101_1, 101_2, 101_3, . . . ) may be the same processors including the same components, but examples are not limited thereto, and they may be implemented as different processors. The one or more processors (e.g., 101_1, 101_2, 101_3, . . . ) may communicate with each other to transmit and receive data to and from each other. Although only three (e.g., 101_1, 101_2, and 101_3) of the one or more processors (e.g., 101_1, 101_2, 101_3, . . . ) are shown as being included in the electronic device 100 for ease of description, examples are not limited thereto, and the number of processors may vary depending on embodiments. The one or more processors (e.g., 101_1, 101_2, 101_3, . . . ) are described below simply as the one or more processors 101_1, 101_2, and 101_3.

In some embodiments, the one or more processors 101_1, 101_2, and 101_3 may simultaneously execute one function to reduce a runtime. In this case, executing the one function on the one or more processors 101_1, 101_2, and 101_3 simultaneously may be referred to as tensor parallel processing, and executing one function on each of the one or more processors 101_1, 101_2, and 101_3 may be referred to as pipeline parallel processing. The one or more processors 101_1, 101_2, and 101_3 may perform the tensor parallel processing in addition to the pipeline parallel processing such that each processor executes a portion of one function allocated thereto.

The memory 102 may store instructions (e.g., programs) executable by the one or more processors 101_1, 101_2, and 101_3. For example, the instructions may include instructions for executing operations of the processor 101_1 and/or instructions for executing operations of the plurality of cores 115 of the processor 101_1. As the instructions stored in the memory 102 are executed on each of the one or more processors 101_1, 101_2, and 101_3, the one or more processors 101_1, 101_2, and 101_3 may perform the operations described below. The memory 120 may be a volatile memory or a non-volatile memory.

The client 110 may be a device or system that transmits, to the electronic device 100, input batches for which functions are to be executed and receives function execution results acquired by executing the functions from the electronic device 100. The input batches to be transmitted may be independent of each other. The client 110 may be in a wireless or wired connection with the electronic device 100 to transmit and receive data. In some embodiments, the electronic device 100 may also be connected to multiple clients to receive input batches from the clients.

In one embodiment, for data inference, the one or more processors 101_1, 101_2, and 101_3 may execute the functions in a predetermined order for the input batches. For example, the one or more processors 101_1, 101_2, and 101_3 may execute functions f₁, f₂, f₃, and f₄ sequentially. In this case, an output in response to an input batch being input to f₁ may be an input to f₂, and an output from f₂ may be an input to f₃. Also, an output from f₄, which is the last to be executed, may be a function execution result from the functions. For example, the one or more processors 101_1, 101_2, and 101_3 may execute the functions for the input batches to output a token (as a result of the data inference), using a language model (e.g., LLM), as expressed in Equation 1 below.

$$Final Output Token = {f}_{4} ( {f}_{3} ( {f}_{2} ( {f}_{1} ( Input Sentence ) ) ) ) \qquad Equation 1$$

Here, an input sentence is an example of an input batch, and a final output token is output as a result of executing functions. In some embodiments, one input batch may include one or more input sentences. For example, the one or more processors 101_1, 101_2, and 101_3 may execute functions for the one or more input sentences to output one or more output tokens. In this case, the one or more output tokens may correspond to the one or more input sentences.

Each of the cores 115 may execute requested instructions or functions. In this case, data or parameters for the cores 115 to compute may be received from the memory 102. A loading time used for receiving the data from the memory 102 may be determined by the size of the data and a memory bandwidth. The memory bandwidth may be shared among the cores 115, which may cause a bandwidth interference. For example, when one of the cores 115 receives data from the memory 102 and another of the cores 115 also accesses the memory 102, a greater amount of time may be used to receive the data. As the available memory bandwidth increases, the loading time used to receive the data or parameters required to execute a function may decrease and the speed at which functions are executed may thus increase. Further, a computation ability (or operation ability) of each of the cores 115 may be predetermined. The processor 101_1 may divide functions to be executed into respective cores of the cores 115 to execute them. As the number of cores for executing the functions increases, the speed at which the functions are executed may increase.

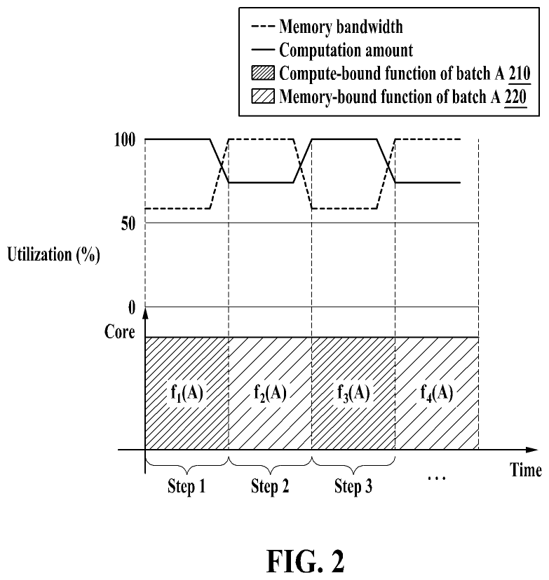

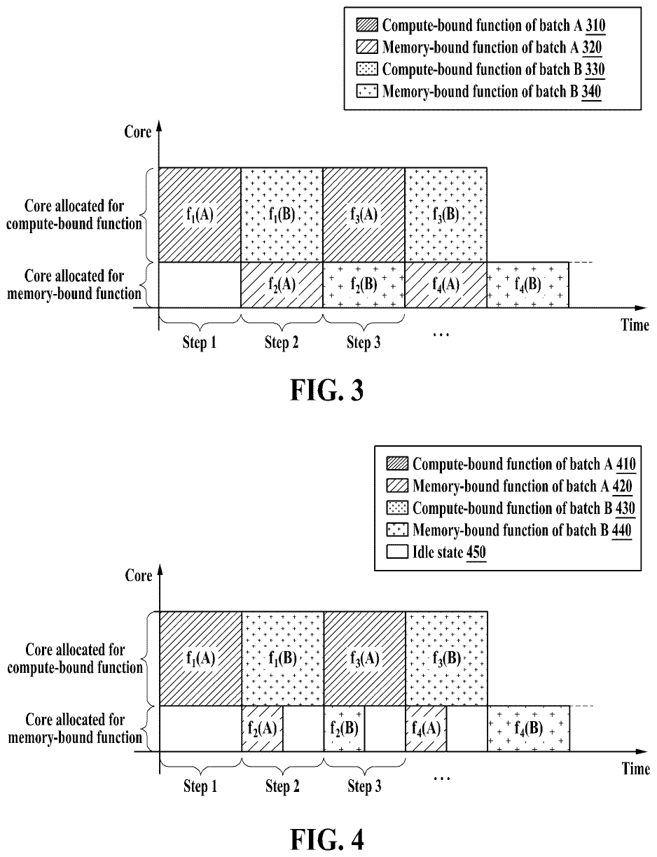

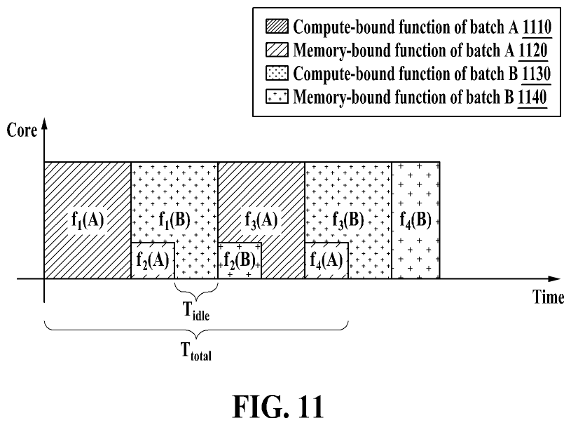

In some embodiments, the electronic device 100 may allocate functions to be executed for each of the input batches to the cores 115 or to the processors 101_1, 101_2, and 101_3 to execute them, thereby increasing the execution speed of the functions and increasing the throughput of the processor 101_1. For example, the electronic device 100 may allocate the functions to the cores 115 by determining whether the functions are fused functions, each fused function including a compute-bound function and a memory-bound function. The electronic device 100 may also allocate the functions to the cores 115 based on a core allocation ratio determined based on a runtime of the compute-bound function and a runtime of the memory-bound function. By classifying the functions into the compute-bound function and the memory-bound function and executing them together on the cores 115, the electronic device 100 may increase the resource utilization of the processor 101_1 and the memory 102 and decrease the latency. The compute-bound function and the memory-bound function are described in detail below with reference to FIG. 2. Further, how the electronic device 100 allocates functions to be executed to cores and executes them is described in detail below with reference to FIGS. 3 through 10, and how the electronic device 100 allocates functions to be executed to processors and executes them is described in detail below with reference to FIGS. 11 through 15.

FIG. 2 illustrates examples of a compute-bound function and a memory-bound function according to one or more example embodiments.

Referring to FIG. 2, a function may be classified as a compute-bound function 210 or a memory-bound function 220 based on a memory bandwidth and a computation amount of the function. The example input batch shown FIG. 2 has only four functions, however, the number of functions in an input batch may vary.

An operator in an electronic device may perform an operation of an input workload with a preset computation speed and a memory bandwidth. A workload for which an operation is to be performed may have a relatively small parameter size but a large computation amount to result in less utilization of memory bandwidth, or may have a relatively small computation amount but a large parameter size to result in less utilization of processor computation speed. Depending on the workload, the processor computation amount or computation speed may be underutilized, or the memory bandwidth may be underutilized.

The compute-bound functions 210 have a computation time longer than a memory loading time, and the memory-bound functions 220 have a memory loading time longer than a computation time. The compute-bound function 210 have the computation time longer than the memory loading time and thus underutilize the memory bandwidth, while the memory-bound functions 220 may have the memory loading time longer than the computation time and thus underutilize the processor computation amount. In the example of FIG. 2, a function f₁ executed in step 1 may be identified as a compute-bound function because its utilization of the memory bandwidth is lower than its utilization of the computation amount, and a function f₂ executed in step 2 may be identified as a memory-bound function because its utilization of computation amount is lower than its utilization of memory bandwidth. As explained next, it may be difficult to simultaneously execute a compute-bound function 210 and a memory-bound function 220 for the same input batch.

Since a processor, while performing an operation for executing a function, may read from a memory parameters required for a subsequent/next operation of the function, a total execution time (or “runtime” herein) of the function may be less than the sum of its computation time and its memory loading time. In this case, the compute-bound function has a computation time that is longer than a memory loading time, and thus the runtime of the compute-bound function may be determined (or limited) by the computation time. Conversely, a memory-bound function may have a memory loading time that is longer than a computation time, and thus a runtime of the memory-bound function 220 may be determined by its memory loading time.

In some embodiments, the electronic device may allocate compute-bound functions (e.g., the compute-bound functions 210) and memory-bound functions (e.g., the memory-bound functions 220) for two different input batches to cores or processors and execute them together, thereby increasing the resource utilization of the processor and the memory. For example, the electronic device may execute one of the compute-bound functions 210 and one of the memory-bound functions 220 simultaneously on a single operator (processor or core).

FIG. 3 illustrates an example of how an electronic device allocates functions to cores according to one or more example embodiments.

Referring to FIG. 3, an electronic device may allocate compute-bound functions 310 and 330 and memory-bound functions 320 and 340 that are to be executed for input batches A and B independent of each other to respective cores to execute them thereon.

In some embodiments, the electronic device may allocate functions to cores based on a core allocation ratio determined based on a runtime of a compute-bound function and a runtime of a memory-bound function. The core allocation ratio may be determined by comparing the runtime of the compute-bound function and the runtime of the memory-bound function based on a ratio at which the functions are allocated to the cores. For example, the core allocation ratio (e.g., a) may be determined to be a value of a such that, in the following case, a runtime t used in one step is minimized (e.g., a time step during which a compute-bound function of one batch and a memory-bound function of another batch are executed on respective cores of a processor).
A total memory bandwidth of a processor: MemBW
A runtime of a compute-bound function when a ratio (α) of cores among multiple cores is allocated: runtime_{C}(α)
A memory bandwidth utilized by a compute-bound function when a ratio (α) of cores among the multiple cores is allocated: MemReq_{C}(α)
A runtime of a memory-bound function when a ratio (1−α) of cores among the multiple cores is allocated and a memory bandwidth of MemBW-MemReq_{C}(α) is used:

$$Throughput : \frac{2}{Number of functions to be executed to generate one token \times t}$$

A runtime of one step when a compute-bound function and a memory-bound function are executed together: t=max (runtime_{C}(α), runtime_{M}(1−α, MemBW−MemReq_{C}(α)))

$${runtime}_{M} ( 1 - α , MemBW - {MemReq}_{C} ( α ) )$$

In this case, the core allocation ratio may be determined to be an allocation ratio that minimizes the runtime t to maximize the throughput, by determining runtime_{C} and runtime_{M} for each allocation ratio. In this case, runtime_{C} and runtime_{M} may be determined differently depending on functions to be executed and a processor. For example, runtime_{C} and runtime_{M} may be determined by the electronic device or a user of the electronic device, or may be determined experimentally as a function that does not change over time.

In the example of FIG. 3, different sections of the vertical axis (e.g., rows) represents discrete different cores (a marked range of the “Core” axis corresponds to a core), the electronic device may allocate the compute-bound functions 310 and 330 to a core allocated for compute-bound functions and allocate the memory-bound functions 320 and 340 to a core allocated for memory-bound functions, based on the core allocation ratio. For example, in step 2, the electronic device may divide the cores to execute the compute-bound function 330 (e.g., f₁(B)) for batch B and the memory-bound function 320 (e.g., f₂(A)) for batch A together. Also, in step 3, the electronic device may execute the compute-bound function 310 (e.g., f₃(A)) for batch A and the memory-bound function 340 (e.g., f₂(B)) for batch B together.

Further, in some embodiments, the processor may execute the functions by tensor parallel processing. For example, in a case where a function f₁ among functions to be executed for an input batch is divided into f_{1,0}, f_{1,1}, f_{1,2}, and f_{1,3}, processors may execute f_{1,0}, f_{1,1}, f_{1,2}, and f_{1,3}, respectively. Even when performing the tensor parallel processing, the electronic device may allocate the divided functions to the cores to execute them. For example, in the example of FIG. 3, f₁(A) represents f_{1,0} acquired from f₁, f₂(A) represents f_{2,0} acquired from f₂, and other divided functions may be executed on different processors.

FIGS. 4 through 6 illustrate an example of how an electronic device allocates functions with different runtimes to cores according to one or more example embodiments.

Referring to FIG. 4, when there is a difference in runtime between a compute-bound function (e.g., 410 and 430) and a memory-bound function (e.g., 420 and 440), an electronic device may allocate remaining functions to a core on which execution of a function is completed and execute them thereon.

Depending on the characteristics of a workload, there may be a difference between the runtime of the compute-bound function and the runtime of the memory-bound function. When there is a difference in runtime, a core on which execution of a function is completed may remain in an idle state. For example, as shown in FIG. 4, the runtime (e.g., runtime_{C}) of the compute-bound function (e.g., 410 and 430) and the runtime (e.g., runtime_{M}) of the memory-bound function (e.g., 420 and 440) may differ by a factor of about two times. In this case, a core allocated for memory-bound functions may enter the idle state when the execution of the memory-bound function (e.g., 420 and 440) is completed. For example, when cores remain in the idle state, 1−α cores are not executed during the difference in runtime (e.g., runtime_{C}−runtime_{M}), and thus resources of a processor may be underutilized. However, the allocation of cores and the runtimes of functions shown in FIG. 4 are provided only for illustrative purposes, and a core allocation ratio and the runtimes of functions may vary according to different embodiments.

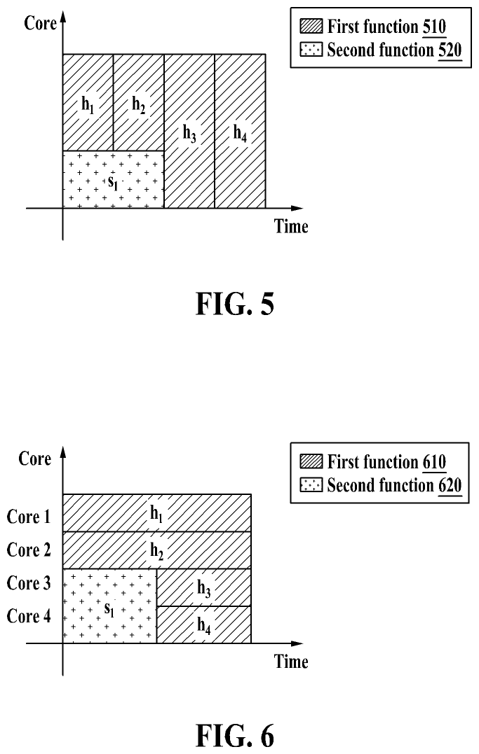

In some embodiments, after execution of functions with a relatively short runtime (e.g., the compute-bound functions 410 and 430 in FIG. 4) is completed, the electronic device may allocate functions with a relatively long runtime (e.g., the memory-bound functions 420 and 440 in FIG. 4) to a core that has executed the functions with the short runtime and may execute the functions with the long runtime thereon. For example, the electronic device may allocate a function that is executed together on another core to a core that has executed a function whose execution has been completed. For example, as shown in FIG. 4, in step 2, when execution of the memory-bound function 420 (e.g., f₂(A)) for batch A is completed, the electronic device may allocate the compute-bound function 430 (e.g., f₁(B)) for batch B to a core allocated for memory-bound functions and additionally execute the compute-bound function 430. A method of allocating functions to cores, when there is a difference in runtime between the compute-bound function (e.g., 410 and 430) and the memory-bound function (e.g., 420 and 440), is described in more detail below with reference to FIGS. 5 and 6.

In addition, a function that merges a memory-bound function and a compute-bound function to execute them together to increase processor resource utilization may be referred to herein as a fused function. For example, the fused function may include one or more compute-bound functions and one or more memory-bound functions. For description, among functions executed in succession for an input batch, compute-bound functions executed in succession may be represented by a single combined function. Similarly, memory-bound functions executed in succession may be represented by a single combined function. By representing the compute-bound functions executed in succession as a single combined function and the memory-bound functions executed in succession as a single combined function, the functions to be executed for the input batch may be construed/distributed such that a compute-bound function and a memory-bound function are executed alternately. For example, when functions to be executed in succession for an input batch are represented as f₁, f₂, f₃, f₄, . . . , the odd-numbered functions (e.g., f₁ and f₃) may be compute-bound functions and the even-numbered functions (e.g., f₂ and f₄) may be memory-bound functions. Conversely, the odd-numbered functions may be memory-bound functions, and the even-numbered functions may be compute-bound functions. The input batches may be input to the processor at different times. The fused function may be determined as a combination of a compute-bound function and a memory-bound function, such that functions to be executed for each of the input batches input at different times are executed together. For example, when input batch B is input after functions up to f₅ for input batch A are executed, the electronic device may execute a fused function that executes f₆ and f₁ simultaneously. For another example, when the input batch B is input after functions up to f₉ for the input batch A are executed, the electronic device may execute a fused function that executes f₁₀ and f₁ simultaneously.

In some embodiments, the electronic device may determine whether functions to be executed for each input batch correspond to a target function that is one of preset fused functions, and allocate the functions to cores to execute them based on a core allocation ratio corresponding to the target function. The electronic device may also determine a function, of which execution is first completed, from among functions included in a fused function, and allocate the functions to the cores to execute them. In one embodiment, the electronic device may predict in advance a function of which execution is first completed among functions included in a fused function based on a runtime of each of the functions. After the execution of that function has been completed, the electronic device may execute the remaining function on a core that has executed the function of which the execution is first completed, based on the fused function.

Referring to FIG. 5, the electronic device may divide some functions having a long runtime, among the functions included in the target function, into a plurality of unit functions and may, when execution of remaining functions excluding the some functions is completed, allocate together some of the unit functions to cores different from cores to which the some functions are allocated and execute them.

A first function 510 may be a function having a relatively longer runtime among the functions included in the target function. A second function 520 may be a function having a relatively a shorter runtime among the functions included in the target function. The first function 510 and the second function 520 may also be referred to herein as a long function and a short function, respectively.

In one embodiment, when the first function 510 is executed as being divided into one or more unit functions, the electronic device may execute some of the unit functions along with the second function 520 and execute remaining functions using all cores after the execution of the second function 520 is completed. The electronic device may allocate together unit functions to be executed subsequently after the execution of the second function 520 is completed to a core that executed the second function 520 to execute them. As shown in the graph of FIG. 5, in a case where the first function 510 is calculated by executing four unit functions h₁, h₂, h₃, and h₄ in succession, and a runtime of the second function 520 (e.g., s₁) is less than a sum of runtimes of the two unit functions h₁ and h₂, the electronic device may execute the functions h₃ and h₄ together on cores allocated for executing the second function 520.

Referring to FIG. 6, the electronic device may divide some functions having a relatively long runtime among the functions included in the target function into a plurality of tasks to be executed in parallel, and may allocate some of the tasks to cores different from cores to which the some functions are allocated and may execute them.

For example, in a case where a first function 610 is difficult to calculate by dividing it into a plurality of unit functions to be executed in succession, or an idle time increases according to a runtime of a second function 620, the electronic device may divide the first function 610 into a plurality of tasks to minimize the idle time and execute some of the plurality of tasks on cores allocated to the second function 620. For example, in a case where the electronic device is to calculate a matrix multiplication performed in deep learning, the electronic device may execute the matrix multiplication by dividing the matrix multiplication into a plurality of tasks. When the execution of the second function 620 is completed, the electronic device may allocate some of the plurality of tasks to the cores that executed the second function 620 and may execute them thereon. In one embodiment, in a case where a processor includes N cores, the electronic device may divide the first function 610 into N tasks, such that the respective cores execute the tasks.

The electronic device may divide the first function 610 into a plurality of tasks with different runtimes. In one embodiment, the electronic device may divide the first function 610 into the plurality of tasks such that certain tasks have a relatively shorter runtime than other tasks (e.g., ordering the tasks by runtime). By executing the tasks with the shorter runtime on the cores executing the second function 620, the electronic device may allow these cores to complete the calculation at the same time as the other cores after calculating the second function 620 and some of the tasks of the first function 610. As shown in the graph of FIG. 6, in a case where the first function 610 is executed as its four tasks h₁, h₂, h₃, and h₄ are executed in parallel, the electronic device may execute the tasks h₃ and h₄ on the cores allocated to execute the second function 620 after the execution of the second function 620 (e.g., s₁) is completed. As shown, cores 3 and 4 may execute h₃ and h₄ having a relatively shorter runtime than h₁ and h₂, after the execution of s₁ is completed, and may thereby complete the execution at the same time as cores 1 and 2.

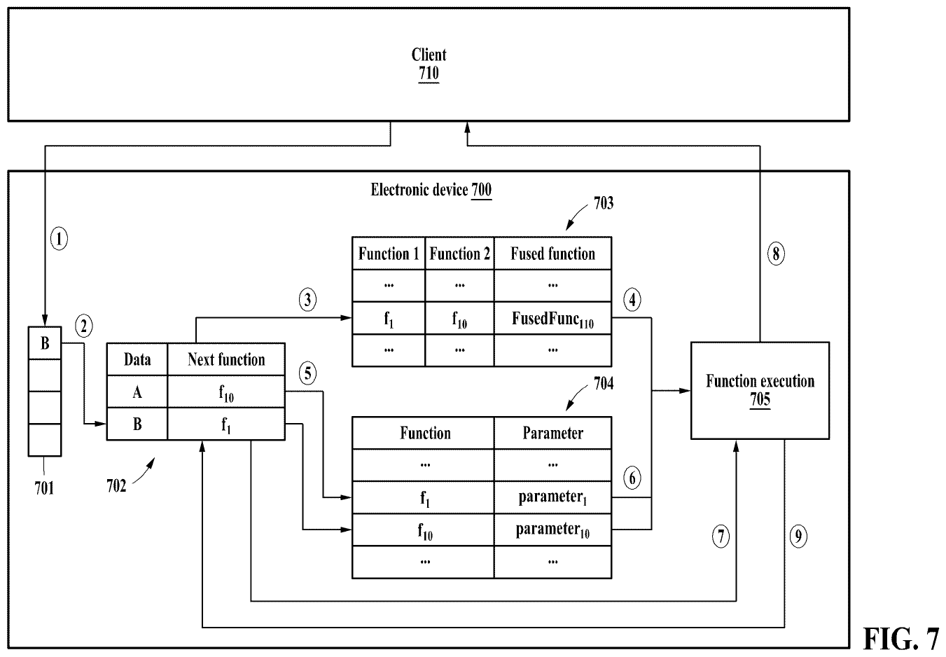

FIG. 7 illustrates an example of how an electronic device uses preset fused functions according to one or more example embodiments.

Referring to FIG. 7, an electronic device 700 may determine whether functions included in work data information 702 are preset fused functions and execute the functions.

A client 710 may transmit input batches to be calculated by the electronic device 700 and receive calculation results. The electronic device 700 may store the input batches received from the client 710 in an input queue 701.

The electronic device 700 may store, in the work data information 702, data of input batches currently being calculated and respective functions to be executed subsequently for the input batches. In this case, when execution of functions is completed for all or some of the input batches stored in the work data information 702, or there is no data, the electronic device 700 may store data for an input batch to be executed subsequently that is stored in the input queue 701.

The electronic device 700 may store, in fused function information 703, fused functions based on combinations of the functions. For example, the fused function information 703 may store fused functions based on combinations of two functions to be executed for an input batch. For example, the fused function information 703 may store fused functions, each of which is based on a combination of a compute-bound function and a memory-bound function to be executed for an input batch. A fused function may also be indicated as “FusedFunc” for ease of description. For example, a fused function based on a combination of a compute-bound function f₁ and a memory-bound function f₁₀ may also be indicated as “FusedFunc₁₁₀.”

The electronic device 700 may determine whether the functions included in the work data information 702 correspond to a target function that is one of the fused functions stored in the fused function information 703 (e.g., may determine if a target function is a fused function). For example, the electronic device 700 may search the fused function information 703 for a fused function including all the functions included in the work data information 702.

The electronic device 700 may store, in parameter information 704, parameters required for operations of the functions to be executed for the input batches.

At operation 705, the electronic device 700 may execute the target function to execute the functions to be executed for the input batches. For example, using the target function, the electronic device 700 may execute together a function that is to be currently executed for input batch A and a function that is to be currently executed for input batch B. The electronic device 700 may execute the functions using the data of the input batches stored in the work data information 702, the target function retrieved from the fused function information 703, and the parameters of the functions corresponding to the target function stored in the parameter information 704. Operation 705 may be executed by an executer included in the electronic device 700.

In some embodiments, the work data information 702, the fused function information 703, and the parameter information 704 may be implemented, in the form of a table, as a work data table, a fused function table, and a parameter table, respectively.

For example, the electronic device 700 may execute functions on cores as follows.
1. At operation \textcircled{1}, the electronic device 700 may store an input batch received from the client 710 in the input queue 701.
2. At operation \textcircled{2}, when there is no data in some or all of the work data information 702, the electronic device 700 may check whether the input batch is present in the input queue 701.
3. At operation \textcircled{3} and operation \textcircled{4}, when the data is present in the work data information 702, the electronic device 700 may search the fused function information 703 for a fused function for that data and transmit the retrieved fused function to the executer. When no fused function is retrieved, the electronic device 700 may perform operation \textcircled{2} again.
4. At operation \textcircled{5} and operation \textcircled{6}, the electronic device 700 may search the parameter information 704 for parameters required to execute the fused function and transmit the retrieved parameters to the executer.
5. At operation \textcircled{7}, the electronic device 700 may transmit data for calculation from the work data information 702 to the executer.
6. At operation 705, the executer of the electronic device 700 may execute the functions using the received fused function, parameters, and data.
7. At operation \textcircled{8}, when, of a calculation result, a final function execution result for the input batch is output, the electronic device 700 may transmit the function execution result to the client 710.
8. At operation \textcircled{9}, when, of the calculation result, there is data that requires a calculation of a subsequent function, the electronic device 700 may store the data in the work data information 702 (i.e., the result may be provided for another function).

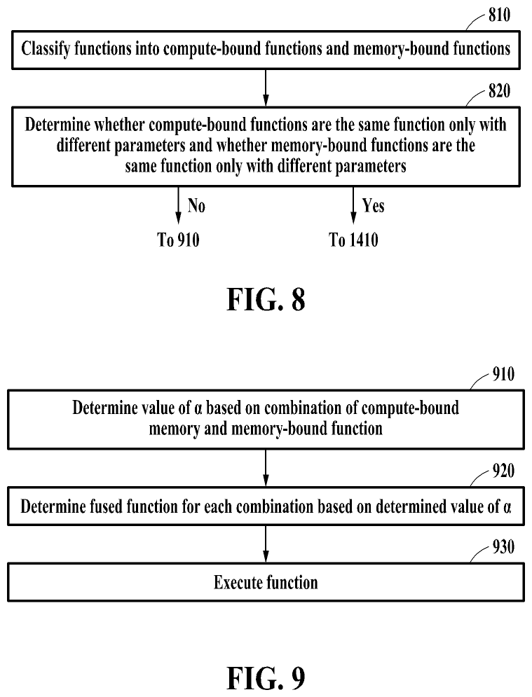

FIG. 8 illustrates an example of classifying functions according to one or more example embodiments.

Referring to FIG. 8, operation 810 and operation 820 may be performed before the execution of functions.

At operation 810, the electronic device may classify functions to be executed for input batches into compute-bound functions and memory-bound functions. The electronic device may classify the functions into the compute-bound functions and the memory-bound functions by comparing the memory loading time and the computation time of the functions.

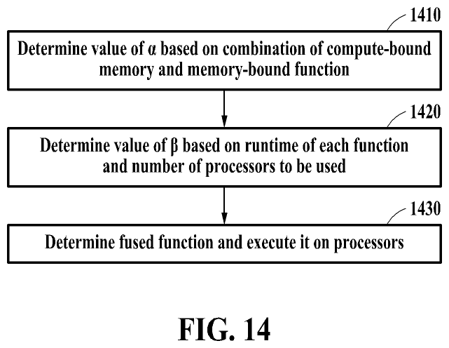

At operation 820, the electronic device may determine whether, among the functions, the compute-bound functions are the same functions only with different parameters and the memory-bound functions are the same functions only with different parameters. Alternatively, the electronic device may determine whether a preset ratio of functions among the compute-bound functions is the same function only with different parameters and whether a preset ratio of functions among the memory-bound functions is the same function only with different parameters. When it is determined that they are not the same function, the electronic device may perform operation 910 described below with reference to FIG. 9. Conversely, when it is determined that they are the same function, the electronic device may perform operation 1410 described below with reference to FIG. 14.

FIG. 9 illustrates an example of determining a fused function and a core allocation ratio according to one or more example embodiments.

At operation 910, the electronic device may determine a value of a, a core allocation ratio, based on a combination of a compute-bound function and a memory-bound function.

At operation 920, the electronic device may determine a fused function for each combination based on the determined value of a. The value of a may be determined differently for each fused function.

At operation 930, the electronic device may execute the fused function to execute functions to be executed for input batches.

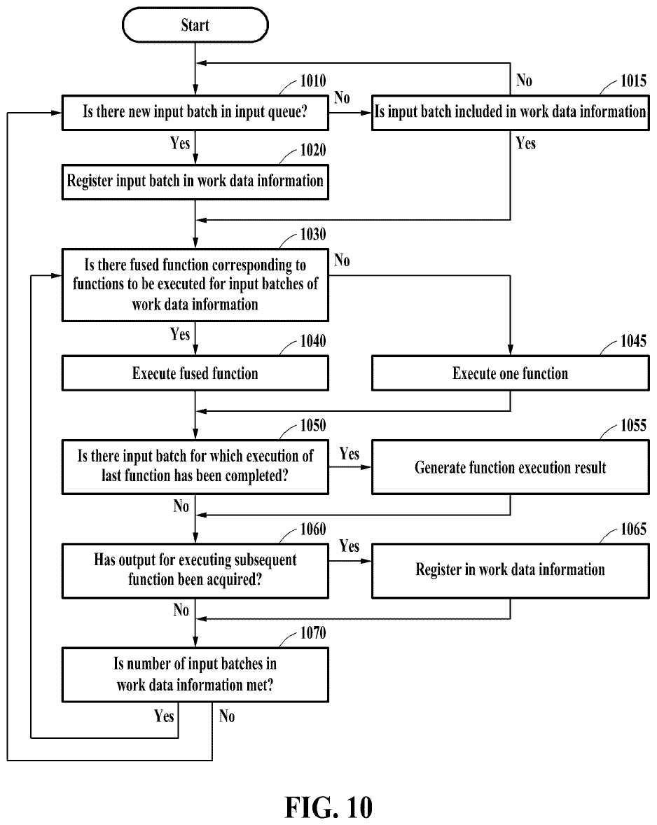

FIG. 10 illustrates an example of allocating functions to cores according to one or more example embodiments.

At operation 1010, the electronic device may determine whether a new input batch is present in an input queue.

At operation 1015, when a new input batch is not present in the input queue, the electronic device may determine whether an input batch to be computed is included in work data. For example, the electronic device may determine whether there are input batches to be computed in the work data.

At operation 1020, when a new input batch is present in the input queue, the electronic device may register the new input batch in work data information. For example, the electronic device may store the new input batch in a work data table. In this case, when the work data information is full of data, operation 1020 may be omitted, and the electronic device may store data it has attempted to store in the work data information and a function to be executed subsequently.

At operation 1030, the electronic device may determine whether there is a fused function corresponding to functions to be executed for the input batches in the work data information. For example, the electronic device may determine whether the fused function including all the functions to be executed for the input batches is present in a fused function information.

At operation 1040, when a fused function corresponding to the functions to be executed is present, the electronic device may execute the fused function. The electronic device may transmit the fused function and parameters to an executer using the work data information (the executor is a component that manages the execution of tasks/functions).

At operation 1045, when a fused function corresponding to the functions to be executed is not present, the electronic device may execute one of the functions.

At operation 1050, the electronic device may determine whether there is an input batch for which execution of a last function is completed among the input batches.

At operation 1055, when the input batch for which the execution of the last function is completed is present, the electronic device may generate a function execution result for the input batch. The electronic device may transmit the function execution result to an appropriate recipient (e.g., a client).

At operation 1060, the electronic device may determine whether an output for executing a subsequent function is acquired. For example, the electronic device may determine whether an output for a function that is not the last function among the functions to be executed for the input batch is acquired.

At operation 1065, when an output for executing the subsequent function is acquired, the electronic device may register the output in the work data information. For example, the electronic device may store a result of the currently executed function in the work data information.

At operation 1070, the electronic device may determine whether the number of input batches stored in the work data information meets a preset number. For example, in a case where two input batches are stored in the work data information, the electronic device may determine whether the two input batches are stored. If not, the electronic device may perform operation 1010, and if so, the electronic device may perform operation 1030.

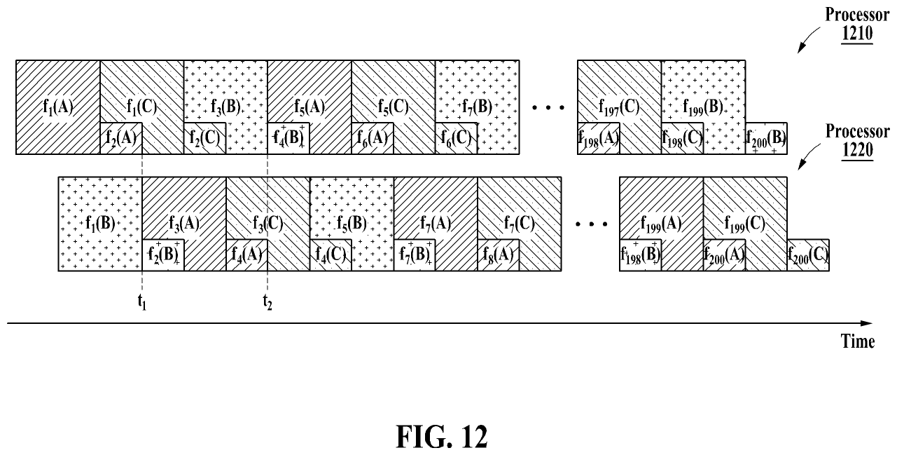

FIGS. 11 and 12 illustrate an example of how an electronic device allocates functions to processors according to one or more example embodiments.

Referring to FIG. 11, an example time-function execution graph acquired when a single processor allocates functions to cores and executes the functions is shown.

In the example of FIG. 11, in a case where one processor executes functions by allocating the functions to cores, there may be a time T_{idle} during which no operation is performed for input batch A, out of a total computation time Tₜₒₜₐₗ for the input batch A. For example, during execution of a compute-bound function 1130 for input batch B after execution of a compute-bound function 1110 and a memory-bound function 1120 for the input batch A, no functions may be executed for the input batch A. Similarly, during execution of the compute-bound function 1110 for the input batch A after execution of the compute-bound function 1130 and a memory-bound function 1140 for the input batch B, no functions may be executed for the input batch B.

Referring to FIG. 12, an electronic device may execute functions by allocating the functions to processors 1210 and 1220 and cores of the processors 1210 and 1220 to reduce a time for which an operation for any input batch is not performed. Although only two processors 1210 and 1220 are shown in FIG. 12 for ease of description, examples are not limited thereto, and the number of processors may be determined differently according to embodiments.

In some embodiments, when compute-bound functions to be executed are the same functions only with different parameters and memory-bound functions are the same functions only with different parameters, the electronic device may execute the functions by allocating the functions to processors. In the example of FIG. 12, in a case where functions to be executed are f₁, f₂, . . . , and f₂₀₀, the odd-numbered functions may be the same compute-bound functions only with different parameters, and the even-numbered functions may be the same memory-bound functions only with different parameters. In this case, the electronic device may execute the functions by allocating the functions to the processor 1210 and the processor 1220 as shown in the graph of FIG. 12 and may thereby execute the functions no or minimal idle time for all input batches.

In some embodiments, when preset functions among functions for any one of input batches are executed, the electronic device may transmit a result value of the preset functions and information about a function to be executed subsequently to a subsequent processor among the processors. For example, when the processor 1210 completes executing f₂(A) for the input batch A at t₁, the processor 1210 may transmit a result value of f₂(A) to the processor 1220, and the processor 1220 may execute f₃(A) for the input batch A (also, f₂(B) for the input batch B). Also, when the processor 1220 completes executing f₄(A) for the input batch A at t₂, the processor 1220 may transmit a result value of f₄(A) to the processor 1210, and the processor 1210 may execute f₅(A) for the input batch A (also, f₄(B) for the input batch B). By allocating the functions to processors and cores of the processors and executing the functions as described herein, the electronic device may maximize the resource utilization of the processors while reducing the latency in execution of functions for a single input batch.

In some embodiments, the number of processors to which functions are to be allocated may be determined based on a runtime ratio between the functions. For example, in a case where a runtime of a short function is β (0<β≤1) times that of a long function, the number N of processors may be determined to be the smallest natural number N when a value of β×N becomes an integer. However, examples are not limited thereto, and the number of processors may be determined in other ways. For example, a value of β may be determined not to be a ratio between a runtime of the short function and a runtime of the long function, but to be more than the ratio. Alternatively, in some embodiments, the value of β may be adjusted to reduce the number of processors rather than reducing the resource utilization.

For example, the electronic device may schedule the executions of the functions for the plurality of processors 1210 and 1220, as follows.
1. When an input batch is received, the processor 1210 may execute a fused function based on the input batch. In this case, a function to be executed in the fused function may be f₁. The processor 1220 may determine whether there is an output to be transmitted from the processor 1210. When an output to be transmitted is present, the processor 1220 may receive the output from the processor 1210 and execute a subsequent function of the function executed by the processor 1210.
2. After the execution of one fused function is completed, the processor 1220 may execute a subsequent fused function. In this case, the executed fused function may be fan and f₂ₖ₊₁ (where n denotes a natural number, and k denotes a non-negative integer). Here, an input of the function f₂n may be an output of a function f₂ₙ₋₁ executed from the processor 1220. Further, the function f₂ₖ₊₁ may be an output of a function f₂ₖ executed on the processor 1210. Before executing the fused function, the processor 1220 may first check whether the processor 1210 has an output to be transmitted to the processor 1220. Depending on a result of the checking, the following operations may be performed.
A. When the output is still being calculated by the processor 1210, the processor 1220 may wait to execute the fused function, and may execute the fused function after receiving the output from the processor 1210. When the processor 1210 transmits the output to the processor 1220, it may also transmit information about which function's result corresponds to the output. Further, the processor 1220 may execute the fused function in the same way even when the processor 1210 transmits the output first.
B. When there is no output to be transmitted from the processor 1210, the processor 1220 may check whether there is a new input batch to be computed. When the new input batch is present, the processor 1220 may execute a fused function that executes functions f₁ and f₂ₙ for a corresponding input batch as an input.
C. When there is no output to be transmitted from the processor 1210 and there is no new input batch, the processor 1220 may execute f₂ₙ.
3. After executing the last function, the processor 1210 and the processor 1220 may transmit a function execution result to an appropriate recipient (e.g., a client). The processor 1220 may check whether the processor 1210 has an output to be transmitted to the processor 1220, and if so, execute a subsequent fused function.

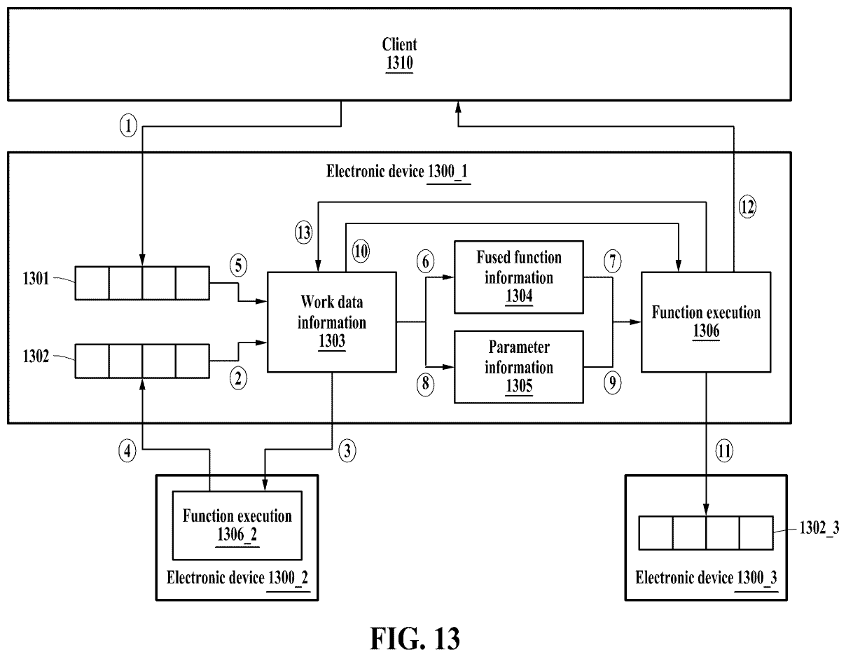

FIG. 13 illustrates an example of how an electronic device executes functions by allocating the functions to processors according to one or more example embodiments.

Referring to FIG. 13, an electronic device 1300_1 may execute functions by allocating the functions to cores and processors based on a core allocation ratio corresponding to a target function and the number of processors for executing the functions. In the example of FIG. 13, the processors may be included in electronic devices 1300_1, 1300_2, and 1300_3, respectively. The electronic devices 1300_2 and 1300_3 may include the same components and perform the same operations as the electronic device 1300_1. Alternatively, one electronic device 1300_1 may include the processors. In this case, the electronic device 1300_2 and the electronic device 1300_3 may be included in the electronic device 1300_1.

For the description of a client 1310, input queues 1301 and 1302, work data information 1303, fused function information 1304, parameter information 1305, and operation 1306, reference may be as described above with reference to FIG. 7.

The electronic device 1300_1 may store, in the input queue 1301, input batches received from the client 1310. The electronic device 1300_1 may store, in an input queue 1302, an output of a function executed at operation 1306_2 of the other electronic device 1300_2 and a function to be executed subsequently. After executing a function at operation 1306, the electronic device 1300_1 may transmit a function execution result to the other electronic device 1300_3 or store the function execution result in the work data information 1303. Alternatively, after executing all functions for an input batch, the electronic device 1300_1 may transmit a function execution result to the client 1310. The electronic device 1300_3 may store the received function execution result in an input queue 1302_3.

For example, the electronic device 1300_1 may execute the functions on the processors of the plurality of electronic devices 1300_1, 1300_2, and 1300_3 as follows.
1. At operation \textcircled{1}, the electronic device 1300_1 may store, in the input queue 1301, an input batch received from the client 1310.
2. At operation \textcircled{2} to operation \textcircled{4}, when there is no data in at least a portion of the work data information 1303, the electronic device 1300_1 may check whether there is an input batch in the input queue 1302.
3. At operation \textcircled{5}, when there is no data in at least some of the work data information 1303, the electronic device 1300_1 may check whether there is a new input batch in the input queue 1301.
4. At operation \textcircled{6} and operation \textcircled{7}, when there is data in the work data information 1303, the electronic device 1300_1 may search the fused function information 1304 for a fused function for the data and transmit the retrieved fused function to an executer. When no fused function is retrieved, the electronic device 1300_1 may perform operation \textcircled{2} again.
5. At operation \textcircled{8} and operation \textcircled{9}, the electronic device 1300_1 may search the parameter information 1305 for parameters required to execute the fused function and transmit the retrieved parameters to the executer.
6. At operation \textcircled{10}, the electronic device 1300_1 may transmit data for calculation from the work data information 1303 to the executer.
7. At operation 1306, the executer of the electronic device 1300_1 may execute the functions using the received fused function, parameters, and data.
8. At operation \textcircled{11}, when, of calculation results, a result to be input to a function to be executed on the subsequent electronic device 1303_3 is output, the electronic device 1300_1 may transmit a function execution result to the subsequent electronic device 1303_3.
9. At operation \textcircled{12}, when, of the calculation results, a final function execution result for the input batch is output, the electronic device 1300_1 may transmit the function execution result to the client 1310.
10. At operation \textcircled{13}, when, of the calculation results, there is data that requires a subsequent function to be calculated, the electronic device 1300_1 may store the data in the work data information 1303.

In one embodiment, the electronic device 1300_2 and the electronic device 1300_3 may perform the same operations as the operations performed by the electronic device 1300_1.

FIG. 14 illustrates an example of allocating functions based on the number of processors according to one or more example embodiments.

At operation 1410, the electronic device may determine a value of a, a core allocation ratio, based on a combination of a trait of a compute-bound function and a trait of a memory-bound function.

At operation 1420, the electronic device may determine a value of β based on a runtime of each function and the number of processors to be used. The value of β may also be adjusted to adjust the number of processors.

At operation 1430, the electronic device may determine a fused function and execute the fused function on a plurality of processors.

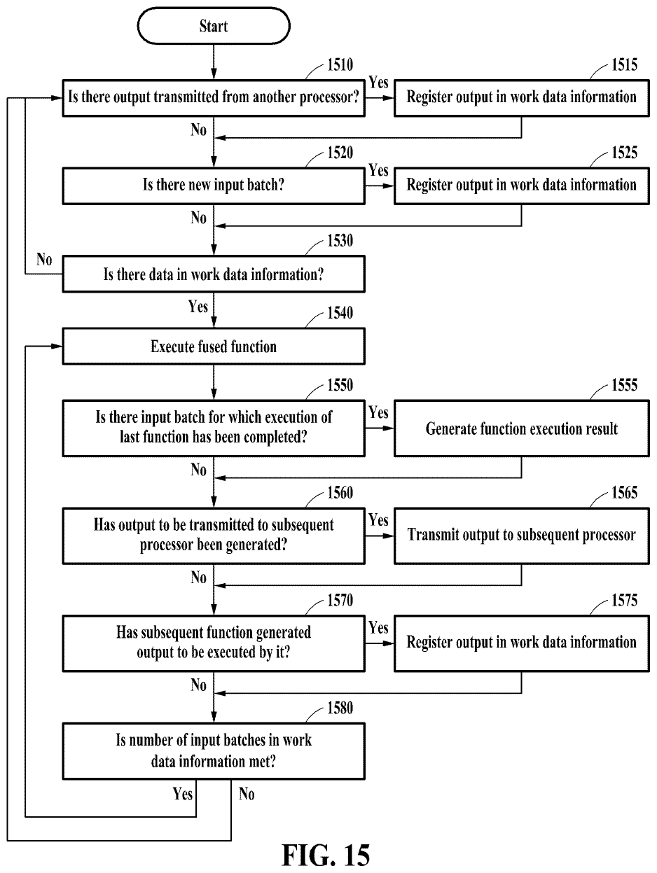

FIG. 15 illustrates an example of allocating functions to processors according to one or more example embodiments.

At operation 1510, the electronic device may determine whether there is an output transmitted from another processor in an input queue.

At operation 1515, when the transmitted output is present, the electronic device may register the output in work data information. When the work data information is full of data, operation 1015 may be omitted, and the electronic device may store data it has attempted to store in the work data information and a function to be executed subsequently.

At operation 1520, the electronic device may determine whether there is a new input batch in the input queue.

At operation 1525, when the new input batch is present, the electronic device may register the input batch in the work data information. When the work data information is full of data, operation 1025 may be omitted, and the electronic device may store data it has attempted to store in the work data information and a function to be executed subsequently.

At operation 1530, the electronic device may determine whether there is data for which functions are to be executed in the work data information. When the data is not present, the electronic device may perform operation 1510.

At operation 1540, when the data is present, the electronic device may execute a fused function for the data. The electronic device may transmit the fused function and parameters to an executer using the work data information.

At operation 1550, the electronic device may determine whether there is an input batch for which execution of a last function is completed.

At operation 1555, when the input batch for which the execution of the last function is completed is present, the electronic device may generate a function execution result for the input batch. The electronic device may also transmit the generated function execution result to an appropriate recipient (e.g., a client).

At operation 1560, the electronic device may determine whether an output to be transmitted to a subsequent processor is generated.

At operation 1565, when the output to be transmitted to the subsequent processor is generated, the electronic device may transmit the output to the subsequent processor.

At operation 1570, the electronic device may determine whether a subsequent function to be executed for the input batch is also an output required to be executed by the electronic device.

At operation 1575, when the subsequent function is also an output required to be executed by the electronic device, the electronic device may register the output in the work data information.

At operation 1580, the electronic device may determine whether the number of input batches in the work data information meets a preset number. The electronic device may perform operation 1510 when the number of input batches does not meet the preset number, and perform operation 1540 when the number of input batches meets the preset number.

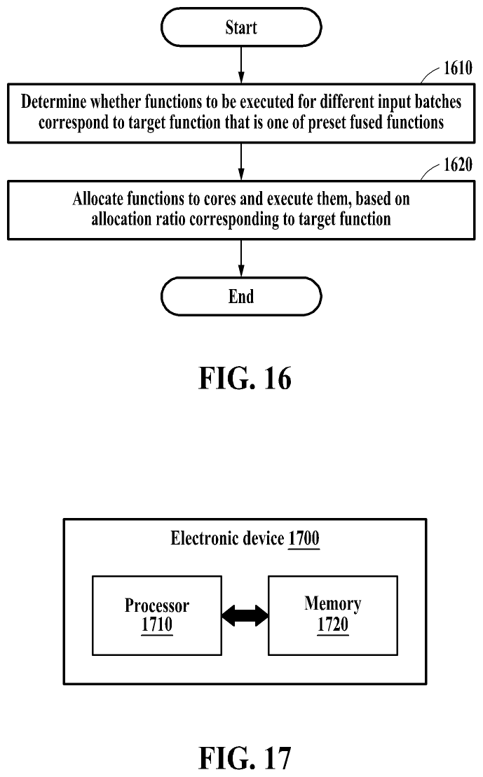

FIG. 16 illustrates an example of a method of operating an electronic device according to one or more example embodiments.

At operation 1610, the electronic device may determine whether functions to be executed for each of independent input batches correspond to a target function that is one of preset fused functions.

At operation 1620, the electronic device may execute the functions by allocating the functions to cores based on a core allocation ratio corresponding to the target function. Using the target function, the electronic device may execute together a function that is to be executed currently for one of the input batches and a function that is to be executed currently for another input batch. When execution of some of functions included in a fused function is completed, the electronic device may execute remaining functions by allocating the remaining functions to cores on which the execution completed. The electronic device may divide some functions with a long runtime among the functions included in the target function into a plurality of unit functions, and may, when execution of remaining functions excluding the some functions is completed, allocate together some of the unit functions to cores different from cores to which the some functions are allocated. The electronic device may divide some functions with a long runtime among the functions included in the target function into tasks to execute them in parallel, and may allocate some of the tasks to cores different from the cores to which the some functions are allocated and execute them. The electronic device may execute the functions using data of the input batches, the target function, and parameters of the functions.

The fused functions may each include a compute-bound function having a computation time longer than a memory loading time and a memory-bound function having a memory loading time longer than a computation time. The fused functions may each include one or more compute-bound functions and one or more memory-bound functions, among the functions. The core allocation ratio may be determined based on a runtime of the compute-bound function and a runtime of the memory-bound function.

To the operations described with reference to FIG. 16, what is described above with reference to FIGS. 1 through 15 is generally applicable.

FIG. 17 illustrates an example of a configuration of an electronic device according to one or more example embodiments.

Referring to FIG. 17, an electronic device 1700 may include a processor 1710. The processor 1710 may include at least one processor. The processor 1710 may include cores (not shown). The electronic device 1700 may further include a memory 1720.

The memory 1720 may store instructions (e.g., a program) executable by the processor 1710. For example, the instructions may include instructions for executing operations of the processor 1710 and/or instructions for executing operations of each component of the processor 1710.

The processor 1710, which is a device that executes instructions or programs or controls the electronic device 1700, may include various processors, such as, for example, a central processing unit (CPU), a graphics processing unit (GPU), and the like. The processor 1710 may determine whether function to be executed for each of independent input batches correspond to a target function that is one of preset fused functions. The processor 1710 may execute the functions by allocating the functions to a plurality of cores based on a core allocation ratio corresponding to the target function.

Using the target function, the processor 1710 may execute together, on the processor 1710, a function that is to be executed currently for one of the input batches and a function that is to be executed currently for another input batch. When execution of some functions among functions included in a fused function is completed, the processor 1710 may execute remaining functions by allocating the remaining functions to cores on which the execution is completed. The processor 1710 may divide some functions with a long runtime among the functions included in the target function into a plurality of unit functions, and may, when execution of the remaining functions excluding the some functions is completed, allocate together some of the unit functions to cores different from the cores to which the some functions are allocated and execute them. The processor 1710 may divide some functions with a long runtime among the functions included in the target function into a plurality of tasks to execute them in parallel, and may allocate some of the tasks to cores different from the cores to which the some functions are allocated and execute them. The processor 1710 may execute the functions using data of the input batches, the target function, and parameters of the functions.

The processor 1710 may execute the functions by allocating the functions to a plurality of cores and a plurality of processors, based on the core allocation ratio corresponding to the target function and the number of processors for executing the functions. When, of the functions, preset functions for any one input batch of the input batches are executed, the processor 1710 may transmit, to a subsequent processor, a result value of the preset functions and information about a function to be executed subsequently.

The number of processors for executing the functions may be determined based on a runtime ratio between the functions.

In addition, the electronic device 1700 may perform any of the operations and/or steps described above.

The examples described herein may be implemented using hardware components, software components and/or combinations thereof. A processing device may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For the purpose of simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such as, parallel processors.

The software may include a computer program, a piece of code, an instruction, or some combination thereof, to independently or collectively instruct and/or configure the processing device to operate as desired. The software and/or data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computing systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded in the media may be specially designed and constructed for the purposes of examples, or they may be of the kind well-known and available to a person of ordinary skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as ROM, RAM, flash memory (e.g., USB flash drives, memory cards, memory sticks, etc.), and the like. Examples of program instructions include both machine code, such as produced by a compiler, and files containing higher-level code that may be executed by the computer using an interpreter.

The above-described hardware devices may be configured to act as one or more software modules in order to perform the operations of the above-described examples, or vice versa.

The computing apparatuses, the electronic devices, the processors, the memories, the displays, the information output system and hardware, the storage devices, and other apparatuses, devices, units, modules, and components described herein with respect to FIGS. 1-17 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-17 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. An electronic device, comprising:
a processor comprising cores; and
a memory storing instructions,
wherein the instructions, when executed by the processor, cause the electronic device to:
determine whether functions to be executed for respective independent input batches correspond to a target function among preset fused functions; and
execute the functions by allocating the functions to the cores based on a core allocation ratio corresponding to the target function,
wherein each of the fused functions comprises:
a compute-bound function having a computation time thereof that is greater than a memory loading time thereof and a memory-bound function having a memory loading time thereof that is greater than a computation time thereof.

2. The electronic device of claim 1, wherein the core allocation ratio is determined based on the runtime of the compute-bound function of the target function and the runtime of the memory-bound function of the target function.

3. The electronic device of claim 1, wherein the instructions, when executed by the processor, cause the electronic device to:
execute, using the target function, a function that is to be currently executed for one input batch among the input batches and a function that is to be currently executed for another input batch among the input batches, together on the processor.

4. The electronic device of claim 1, wherein the instructions, when executed by the processor, cause the electronic device to:
in response to execution of some of the functions comprised in a fused function being completed, allocate remaining functions to cores that have completed the execution and execute them thereon.

5. The electronic device of claim 1, wherein the instructions, when executed by the processor, cause the electronic device to:
divide some functions, based on runtime length thereof, among functions comprised in the target function into unit functions; and
in response to execution of remaining functions excluding the some functions being completed, allocate together some of the unit functions to cores different from cores to which the some functions are allocated and execute them thereon.

6. The electronic device of claim 1, wherein the instructions, when executed by the processor, cause the electronic device to:
divide some functions, based on runtimes thereof, among functions comprised in the target function into a plurality of tasks to be executed in parallel; and
allocate some of the tasks to cores different from cores to which the some functions are allocated and execute them thereon.

7. The electronic device of claim 1, wherein the instructions, when executed by the processor, cause the electronic device to:
execute the functions, using data of the input batches, the target function, and parameters of the functions.

8. The electronic device of claim 1, wherein each of the fused functions comprises:
one or more compute-bound functions and one or more memory-bound functions, among the functions.

9. An electronic device, comprising:
a processor comprising cores; and
a memory storing instructions,
wherein the instructions, when executed by the processor, cause the electronic device to:
determine whether functions to be executed for respective independent input batches correspond to a target function among preset fused functions; and
execute the functions by allocating, based on a core allocation ratio corresponding to the target function and the number of processors for executing the functions, the functions to the cores and the processors,
wherein each of the fused functions comprises:
a compute-bound function having a computation time thereof that is greater than a memory loading time thereof and a memory-bound function having a memory loading time thereof that is greater than a computation time thereof.

10. The electronic device of claim 9, wherein the instructions, when executed by the processor, cause the electronic device to:
in response to preset functions among the functions being executed for one input batch among the input batches, transmit a result value of the preset functions and information about a function to be executed subsequently to a subsequent processor among the processors.

11. The electronic device of claim 9, wherein the number of processors for executing the functions is determined based on a runtime ratio between the functions.

12. A method of operating an electronic device, comprising:
determining whether functions to be executed for respective independent input batches correspond to a target function that among preset fused functions; and
executing the functions by allocating the functions to cores based on a core allocation ratio corresponding to the target function,
wherein each of the fused functions comprises:
a compute-bound function having a computation time thereof that is greater than a memory loading time thereof and a memory-bound function having a memory loading time thereof that is greater than a computation time thereof.

13. The method of claim 12, wherein the core allocation ratio is determined based on the runtime of the compute-bound function of the target function and a runtime of the memory-bound function of the target function.

14. The method of claim 12, wherein the executing of the functions by allocating the functions to the cores comprises:
executing, using the target function, a function that is to be currently executed for one input batch among the input batches and a function that is to be currently executed for another input batch among the input batches, together on the processor.

15. The method of claim 12, wherein the executing of the functions by allocating the functions to the cores comprises:
in response to execution of some functions among functions comprised in a fused function being completed, allocating remaining functions of the fused function to cores that have completed the execution and executing them thereon.

16. The method of claim 12, wherein the executing of the functions by allocating the functions to the cores comprises:
dividing some functions having a long runtime among functions comprised in the target function into unit functions; and
in response to execution of remaining functions excluding the some functions being completed, allocating together some of the unit functions to cores different from cores to which the some functions are allocated and executing them thereon.

17. The method of claim 12, wherein the executing of the functions by allocating the functions to the cores comprises:
dividing some functions, based on runtimes thereof, among functions comprised in the target function into a plurality of tasks to be executed in parallel; and
allocating some of the tasks to cores different from cores to which the some functions are allocated and executing them thereon.

18. The method of claim 12, wherein the executing of the functions by allocating the functions to the plurality of cores comprises:
executing the functions, using data of the input batches, the target function, and parameters of the functions.

19. The method of claim 12, wherein each of the fused functions comprises:
one or more compute-bound functions and one or more memory-bound functions, among the functions.

20. A non-transitory computer-readable storage medium storing instructions that, when executed by a processor, cause the processor to perform the method of claim 12.
